(19) United States
(12) Patent Application Publication
(10) Pub. No.: US 2009/0228816 A1
(43) Pub. Date: Sep. 10, 2009

(54) Method and system for realising on-line electronic purchase transaction between a buyer and a merchant

(76) Inventor: Andras Vilmos, Budapest (HU)

Correspondence Address: Olson & Cepuritis, LTD., 20 NORTH WACKER DRIVE, 36TH FLOOR, CHICAGO, IL, 60606, US

(21) Appl. No.: 12/380,946

(22) Filed: Mar. 4, 2009

Related U.S. Application Data
(63) Continuation-in-part of application No. 12/322,602, filed on Feb. 4, 2009.
Application No. 12/322,602 is a continuation-in-part of application No. 10/518,951, filed on Sep. 22, 2005, now abandoned.
Application No. 10/518,951 is a continuation-in-part of application No. 10/432,096, filed on May 20, 2003.

(30) Foreign Application Priority Data
Nov. 20, 2000 (HU) P 0004604
Jun. 17, 2002 (HU) P 0202003

(51) Int. Cl. G06Q 30/00; G06Q 20/00; G06F 15/16; G06Q 10/00; G06F 3/048

(52) U.S. Cl. 715/764; 705/35; 709/204; 705/29; 705/30; 705/44; 709/227

(57) ABSTRACT

The invention relates to a method for realising on-line electronic purchase transaction between a buyer and a merchant, the buyer having a buyer communication means, the merchant having a merchant system, a communication network being provided for allowing data exchange between the buyer communication means and the merchant system, the merchant system comprising a purchase offer site, and the merchant system being configured to allow for selecting at least one item of purchase via the purchase offer site; the method comprising the steps of:
providing a buyer web-pay module at the buyer communication means;
providing a merchant web-pay module at the merchant system;
storing static merchant data by the merchant web-pay module and/or by the merchant system, the static merchant data including merchant identification data for a financial service provider;
initiating a communication between the buyer web-pay module and the merchant web-pay module;
providing dynamic transaction data and optionally also static merchant data to the merchant web-pay module by the merchant system;
providing transaction data comprising dynamic transaction data and static merchant data to the buyer web-pay module by the merchant web-pay module; and
generating a transaction order on the basis of the received transaction data via the buyer web-pay module.

The invention further relates to a system and web-pay modules for performing the method according to the invention.

### CROSS-REFERENCE TO RELATED APPLICATION

This application is a continuation-in-part of co-pending U.S. Ser. No. 12/322,602, filed on Feb. 4, 2009, U.S. Ser. No. 10/518,951, filed on Sep. 22, 2005, and U.S. Ser. No. 10/432,096, filed on May 20, 2003, all being incorporated herein by reference in their entireties.

### FIELD OF THE INVENTION

The present invention relates to a method and system for realising on-line electronic purchase transaction between a buyer and a merchant.

### BACKGROUND OF THE INVENTION

For the sake of briefness and clarity hereinafter a method or system according to the invention for realising on-line financial transaction between a buyer and a merchant will be referred to as a web-pay method or system respectively. By no means is this term to be interpreted as any reference to known systems or in any other limiting way.

With the development of telecommunications and computer technology and with the globalisation of commercial activity solutions for supporting the so-called “electronic purchasing transactions” have gained increasing ground. The main characteristic of a group of these solutions is that the merchant offers its products or services on its Internet website giving their description and pictures here. The list and other data of the products or services shown on the merchant's website are generally accessible for the potential buyer via a communication network and corresponding communication means, e.g. Internet cable network and a computer provided with network card or mobile Internet and laptop/notepad/cell phone with wireless access or similar means for accessing the mobile Internet.

The on-line purchase is generally realised as follows. The buyer accesses the merchant's sales or purchase offer site (e.g. a html website offering products or services for purchase) via the buyer communication means (such as his own computer) and selects at least one offered item with the intention to purchase it. The buyer can then initiate on-line purchase through the connection established between the merchant's and the buyer's computer by providing all the information required by the merchant in order to enable the merchant to collect the transaction value (i.e. the purchase price—the value of the selected items) from the buyer's bank. For this type of on-line purchase to take place the buyer must provide his personal data, including confidential personal data such as his name and credit card number, on the merchant's website. Using the personal data provided by the buyer the merchant issues a collection request and sends it to the buyer's bank (or other financial service provider), generally via his own bank.

However, this commonly applied protocol has a number of drawbacks. Firstly, very high network security is required, in order to protect the buyer's confidential personal data that he must provide at the merchant's website. Providing sufficient network security is a constant technical challenge, the data transmission must necessarily involve data encryption, and the merchant's homepage and sales system must be protected against hackers, the provided personal data must be stored at least temporarily yet still has to remain inaccessible to third parties including even the merchant's own internal staff.

A further deficiency of the purchase initiating procedures based on this widespread model is that their application is mainly controlled by the merchant. The buyer can only proceed according to the on-line purchase protocol adopted at the merchant's website—the buyer has no effective control over the payment once having provided his personal data enabling the merchant to send a collection request to the buyer's bank. The buyer has no real guarantees against misuse (e.g. requesting a larger amount than the actual purchase value, initiating repeated transactions) since the final payment request for the buyer's bank is issued by the merchant, thus depriving the buyer of the possibility of checking or authorising the actual payment request. Lack of trust on the buyer's side may, because of the confidential nature of the required information, result in a failure of carrying out the purchase. (This existing lack of trust is proven by the high ratio of interrupted online purchases and abandoned shopping carts, at the point when buyers are realizing what type of data they need to provide to carry out the payment transaction.)

This problem has been addressed in WO 03/107230 disclosing a system, wherein the on-line payment protocol is inversed, i.e. the merchant sends transaction particulars to the buyer, who must authorise and forward the transaction order to his own financial service provider (bank). This is an efficient way of protecting the buyer's personal data and in particular credit card or bank account number since no such information need be provided to the merchant.

However, the above disclosure does not provide for a convenient way of implementing the solution in existing systems. Merchants already having a well-established system for offering products and services on their website and for supporting the on-line financial transaction to be carried out in connection with the purchase are unwilling to apply major changes in their system as they may be costly or any such change carries the risk of temporary dysfunctions or unavailability of their services.

It is an object of the present invention to provide a web-pay method and system allowing for a buyer initiated and buyer controlled on-line financial transaction. It is a further object of the present invention to provide a web-pay method and system which can be easily implemented with existing merchant systems requiring no real modification of the existing system. It is a further object to provide a web-pay system which is convenient to use by a buyer. It is a further object of the invention to provide a web-pay method and system allowing for real-time on-line financial transactions.

### SUMMARY OF THE INVENTION

In a first aspect of the invention the above objects are achieved by a method for realising on-line electronic purchase transaction between a buyer having a buyer communication means and a merchant having a merchant system, wherein the buyer communication means and the merchant system are connectable to form a communication network; the method comprising the steps of:
providing a purchase offer site at the merchant system, and configuring the merchant system to allow for selecting at least one item of purchase via the purchase offer site;
providing a merchant web-pay module at the merchant system;
providing a static merchant data store at the merchant system for storing static merchant data including merchant identification data for a financial service provider;
configuring the merchant system for allowing for initiating communication between the buyer communication means and the merchant web-pay module;
providing the merchant web-pay module with dynamic transaction data via the merchant system;
providing the merchant web-pay module with static transaction data from the static merchant data store; and
transmitting transaction data comprising dynamic transaction data and static merchant data to the buyer communication means via the merchant web-pay module; wherein the transaction data allows for a transaction order to be generated.

The method preferably comprises configuring the merchant system to create the dynamic transaction data based on information provided by the buyer in connection with selecting the at least one item of purchase.

The method preferably comprises allowing for initiating communication between the buyer communication means and the merchant web-pay module comprises configuring the merchant system:
to provide a transaction ID for identifying transaction particulars in connection with the items selected on the purchase offer site, and
to provide a communication link information for communication with the merchant web-pay module.

The method preferably further includes configuring the merchant system to provide the transaction ID and the communication link information in information fields of the purchase offer site; and to tag the information fields.

The method preferably allows for initiating communication between the buyer communication means and the merchant web-pay module comprises:
providing a web-pay initiating command on the purchase offer site;
sending the buyer communication means communication link information for establishing a connection with the merchant web-pay module in response to activation of the web-pay initiating command.

In a second aspect the invention provides a method for realising on-line electronic purchase transaction between a buyer having a buyer communication means and a merchant having a merchant system comprising a purchase offer site, the buyer communication means and the merchant system being connectable via a communication network; the method comprising the steps of:
providing a buyer web-pay module at the buyer communication means;
selecting at least one item of purchase on the purchase offer site via the buyer communication means;
requesting transaction data comprising dynamic transaction data and static merchant data from the merchant system by the buyer web-pay module; and
generating a transaction order on the basis of the received transaction data via the buyer web-pay module.

The method preferably comprises:
obtaining via the buyer web-pay module transaction ID and communication link information from the purchase offer site for requesting the transaction data;
sending the transaction ID to a designee defined by the communication link information via the buyer web-pay module;
requesting the transaction data comprising dynamic transaction data and static merchant data—related to the transaction ID—via the buyer web-pay module from the designee defined by the communication link information.

The method preferably comprises:
storing static buyer data by the buyer web-pay module, the static buyer data including buyer identification data for at least one buyer's financial service provider; and
generating a transaction order on the basis of the received transaction data and the stored static buyer data via the buyer web-pay module.

The method preferably comprises:
inputting additional data via a data input interface,
including the inputted additional data in the generated transaction order.

The method preferably comprises:
storing financial service provider identification data by the buyer web-pay module of at least one buyer's financial service provider;
authorising the transaction order,
transmitting the authorised transaction order to at least one buyer's financial service provider via the buyer web-pay module based on the stored financial service provider identification data.

The method preferably further includes:
providing a browser at the buyer communication means for accessing the merchant's purchase offer site;
providing a web-pay module activation interface on the toolbar of the browser;
activating the web-pay module activation interface; and
establishing a new communication session between the buyer web-pay module and the designee defined by the communication link information.

In a third aspect the invention provides a method for realising on-line electronic purchase transaction between a buyer having a buyer communication means and a merchant; the method comprising the steps of:
providing a financial service provider web-pay module at the buyer's financial service provider;
receiving a transaction order transmitted by the buyer communication means to the financial service provider web-pay module over a communication network;
identifying via the financial service provider web-pay module merchant identification data comprising contact information for sending an intended payment notification to the merchant;
obtaining the transaction value from the dynamic transaction data; and
if sufficient funds are available on the buyer's account for carrying out the transaction, reserving the required funds and sending the intended payment notification to the merchant via the contact information.

In a further aspect the invention provides a web-pay system for realising on-line electronic purchase transaction between a buyer and a merchant,

the web-pay system comprising:
a buyer web-pay module adapted to be installed on a buyer communication means;
a merchant web-pay module adapted to be installed on a merchant system which is configured:
   to host a purchase offer site;
   to allow for selecting at least one item of purchase via the purchase offer site;
   to create dynamic transaction data; and
   to provide for initiating communication between the buyer web-pay module and the merchant web-pay module;
the buyer web-pay module and the merchant web-pay module being connectable with one another to form a communication network,
the merchant web-pay module being configured:
   to obtain dynamic transaction data from the merchant system;
   to obtain static merchant data from a static merchant data store;
   to provide the buyer web-pay module with transaction data comprising dynamic transaction data and static merchant data; and
the buyer web-pay module being configured to generate a transaction order on the basis of the received transaction data.

Preferably the merchant system is further configured:
to provide a transaction ID for identifying dynamic transaction data created in connection with the items selected on the purchase offer site,
to provide communication link information; and

the buyer web-pay module being configured:
to obtain the transaction ID and the communication link information from the merchant system;
to send the transaction ID to the merchant web-pay module for allowing the merchant web-pay module to obtain dynamic transaction data from the merchant system in connection with the transaction ID.

Preferably the buyer communication means comprises a browser for accessing the merchant's purchase offer site; and the buyer web-pay module comprises a web-pay module activation interface, which can preferably be added to the toolbar of the browser.

Preferably the transaction ID and the communication link information are provided in information fields on the purchase offer site, the information fields being tagged to be recognised by the buyer web-pay module.

Preferably the purchase offer site comprises a web-pay initiating command and the merchant system is configured to send to the buyer communication means communication link information for establishing a connection with the merchant web-pay module in response to activation of the web-pay initiating command.

Preferably the buyer web-pay module comprises static buyer data store for storing static buyer data including buyer identification data for the buyer's financial service provider; and the buyer web-pay module being further configured to include at least part of the static buyer data in the generated transaction order.

Preferably the buyer web-pay module further comprises authorisation data input field for authorising the transaction order.

Preferably the static buyer data store of the buyer web-pay module further comprises financial service provider identification data store area for storing information of the buyer's financial service provider; and the buyer web-pay module is further configured to transmit an authorised transaction order to the buyer's financial service provider based on the stored financial service provider identification data.

Preferably financial service provider identification data may be stored for a plurality of financial service providers, and the buyer web-pay module comprises means for selecting one of the financial service providers for transmitting the transaction order to.

Preferably the web-pay system comprises a financial service provider web-pay module at the buyer's financial service provider; the financial service provider web-pay module being configured:
to receive a transaction order sent by a buyer web-pay module;
to identify the merchant identification data comprising contact information for sending an intended payment notification directly or indirectly to the merchant;
to obtain the transaction value from the dynamic transaction data; and
if sufficient funds are available on the buyer's account, to arrange for reserving the required funds and to send the intended payment notification to the merchant using the contact information.

Preferably the merchant identification data comprising information on the merchant's financial service provider; a merchant financial service provider web-pay module is provided at the merchant's financial service provider; the buyer financial service provider web-pay module is configured to send the intended payment notification to the merchant financial service provider web-pay module; and the merchant financial service provider web-pay module is configured to forward the intended payment notification to the merchant web-pay module.

In a further aspect the invention provides a merchant web-pay module for realising on-line electronic purchase transaction between a buyer having a communication means and a merchant having a merchant system, wherein the merchant web-pay module is adapted to be installed on the merchant system, and the merchant web-pay module is connectable with the buyer communication means to form a communication network, and the merchant web-pay module is configured:
to obtain dynamic transaction data from the merchant system;
to obtain static merchant data from a static merchant data store;
to create transaction data comprising dynamic transaction data and static merchant data; and
to transmit the transaction data to the buyer communication means.

Preferably the merchant system is configured:
to host a purchase offer site;
to allow for selecting at least one item of purchase via the purchase offer site;
to create dynamic transaction data; and
to provide for initiating communication between the buyer communication means and the merchant web-pay module.

Preferably the static merchant data store is provided at the merchant system for storing static merchant data including merchant identification data for a financial service provider.

Preferably the static merchant data store is provided in the merchant web-pay module for storing static merchant data including merchant identification data for a financial service provider.

Preferably the merchant system is further configured:
to provide a transaction ID for identifying dynamic transaction data created in connection with the items selected on the purchase offer site, and
to provide communication link information for communication with the merchant web-pay module.

Preferably the transaction ID and the communication link information are provided in information fields on the purchase offer site, the information fields being tagged.

Preferably the purchase offer site comprises a web-pay initiating command and the merchant system is configured to send to the buyer communication means communication link information for establishing a connection with the merchant web-pay module in response to activation of the web-pay initiating command.

In a further aspect the invention provides a buyer web-pay module for realising on-line electronic purchase transaction between a buyer having a communication means and a merchant having a merchant system hosting a purchase offer site, wherein the merchant web-pay module is adapted to be installed on the merchant system, and the merchant web-pay module is connectable with the buyer communication means to form a communication network, and the buyer web-pay module is configured:
to obtain transaction ID and communication link information from the merchant system for requesting the transaction data;
to send the transaction ID to a designee defined by the communication link information;
to request transaction data related to the transaction ID from the designee defined by the communication link information; and
generating a transaction order on the basis of the received transaction data.

Preferably the buyer web-pay module comprises a web-pay module activation interface, which can preferably be added to a toolbar of an Internet browser.

Preferably the buyer web-pay module comprises static buyer data store for storing static buyer data including buyer identification data for the buyer's financial service provider; and the buyer web-pay module being further configured to include at least part of the static buyer data in the generated transaction order.

Preferably the static buyer data store of the buyer web-pay module further comprises financial service provider identification data store area for storing information of the buyer's financial service provider; and the buyer web-pay module is further configured to transmit an authorised transaction order to the buyer's financial service provider based on the stored financial service provider identification data.

Preferably financial service provider identification data may be stored for a plurality of financial service providers, and the buyer web-pay module comprises means for selecting one of the financial service providers for transmitting the transaction order to.

Preferably the buyer web-pay module further comprises authorisation data input field for authorising the transaction order.

It is to be appreciated that the components of the web-pay system, i.e. the web-pay modules (the buyer web-pay module, the merchant web-pay module and optionally the financial service provider web-pay module) may all be software applications (computer programs) provided on computer readable media or software applications installed on the buyer communication means, the merchant system and the financial service provider system respectively.

The invention may be applied with any merchant system fulfilling the requirement of comprising a purchase offer site, and being configured to allow for selecting at least one item of purchase via the purchase offer site. For example the merchant system may be a server hosting a common e-shopping web site. One of the benefits of the inventive web-pay system and the inventive web-pay method is that it is provided to cooperate with an existing merchant system, hence the merchant need not replace his existing system in order to apply the present invention.

The components of the web-pay system and method may be adopted for any specific communication network as is clear for the skilled person.

In the context of the present invention a web-pay module being provided for use with a buyer communication means, a merchant system or a financial service provider system is understood to comprise the possibility that the web-pay module is installable at a buyer communication means, at a merchant system or at a financial service provider system respectively. A single web-pay module may possess all the required features in order to be able to function both as the buyer web-pay module, the merchant web-pay module and the financial service provider web-pay module. Alternatively a specific web-pay module can be provided for any or each participant (i.e. a buyer-only web-pay module, etc.).

Further details of the invention will be apparent from the accompanying figures and exemplary embodiments.

### BRIEF DESCRIPTION OF THE DRAWINGS

In the Drawings,

FIG. 1 is a schematic diagram of a preferred embodiment of the web-pay system according to the invention.

FIG. 2 is a schematic view of browser illustrating a merchant's purchase offer site and a web-pay module initiating interface.

### DESCRIPTION OF PREFERRED EMBODIMENTS

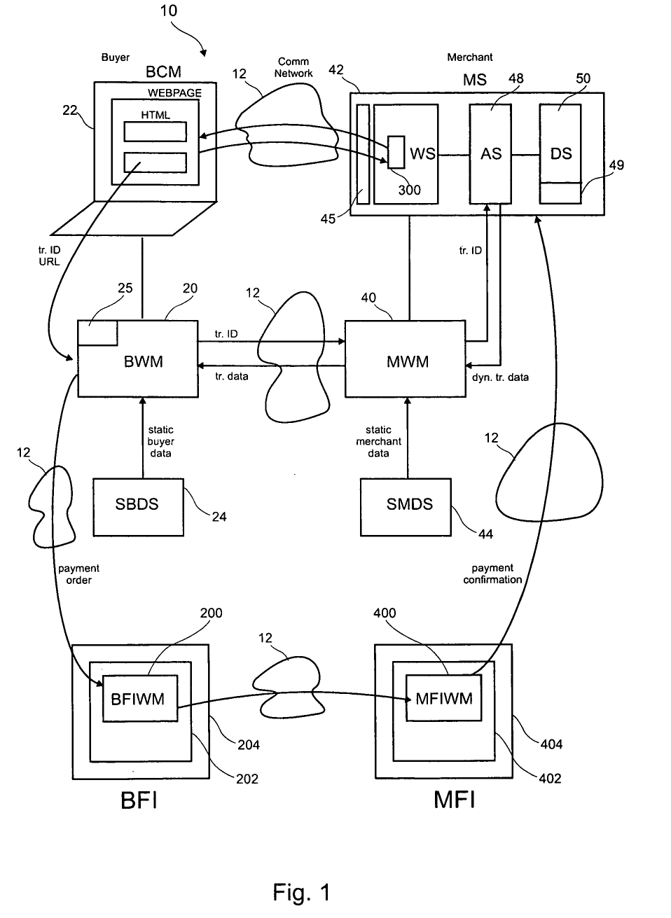

FIG. 1 illustrates a preferred embodiment of the inventive web-pay system 10 comprising a buyer web-pay module 20 installed on a buyer communication means 22 and a merchant web-pay module 40 installed on a merchant's system 42. The buyer communication means 22 may be for example a home computer, a notebook, a palmtop, a mobile phone, or any other suitable device having means for accessing a communication network 12 which allows for data exchange. In a preferred embodiment the communication network 12 may be a global communication network such as the Internet or a local area network (LAN) provided within a facility, or a combination of these wherein the global communication network is accessible via a LAN. Furthermore, the communication network 12 may be a conventional cable network or a wireless network or a combination of these. Accordingly, the buyer communication means 22 can be any suitable device for accessing the global/local fixed/wireless communication network, e.g. a computer having a suitable network card.

The web-pay system 10 may optionally comprise a buyer financial service provider web-pay module 200 installed on the buyer financial service provider system 202 of the buyer's financial service provider 204. The web-pay system may further comprise a merchant financial service provider web-pay module 400 installed on the merchant financial service provider system 402 of the merchant's financial service provider 404. The buyer financial service provider system 202 and the merchant financial service provider system 402 may be conventional systems applied by financial service providers (such as a financial institution, bank, mobile network operator acting in an account manager capacity, etc.), and may comprise one or more servers (hardware) or a single server having a plurality of server software installed thereon.

The financial service provider web-pay modules 200 and 400 are not indispensable for initiating an on-line purchase transaction between a buyer and a merchant, thus the web-pay system 10 does not necessarily require financial service provider web-pay modules 200 and 400 to be installed at the buyer's financial service provider 204 and the merchant's financial service provider 404. However, in the following description a preferred embodiment is described wherein the financial service provider systems 202 and 402 are equipped with web-pay modules 200 and 400 respectively. Furthermore, it is to be noted that the buyer's financial service provider 204 and the merchant's financial service provider 404 may coincide. As this is a simplified version of the described embodiment only the relevant differences will be pointed out without reciting all the common features.

The buyer web-pay module 20 installed on the buyer communication means 22 has a static buyer data store 24 for storing the static buyer data, which includes the buyer's personal data required for issuing a transaction order to the buyer's financial service provider 204. Such personal data may include the buyer's name, identification number, client number, digital signature, biometric identification data, or any other data necessary for identifying the buyer at his financial service provider 204. The static buyer data store 24 may be used for storing other type of buyer related data as well, such as communication link information or any other information for initiating a connection between the buyer web-pay module 20 and the financial service provider system 202. The buyer web-pay module 20 may store the communication link information of more than one financial service provider 204, should the buyer have more than one financial service provider 204 via which he may wish to settle an electronic transaction. The buyer web-pay module 20 may also store personal information in respect of more than one accounts held at one or more financial service providers, thus allowing the buyer to select any of them for a specific transaction as will be explained later on.

The buyer web-pay module 20 may be a multi-user module, in which case the static buyer data store 24 may store the static buyer data of all the users of the specific web-pay module and other buyer related data may include user accounts, user preferences and user settings.

The buyer web-pay module 20 may also include a data input interface 25 for allowing the buyer to include additional data in its communication with the buyer's financial service provider 204, e.g. additional data that the buyer does not wish to store in the buyer web-pay module 20.

The merchant system 42 is preferably a computer server, which may include a plurality of server software, or it may be a group of servers comprising separate servers (hardware). The merchant system 42 typically comprises—either in the form of server software or as separate servers—a firewall 45, a webserver 46, an application server 48, and a database server 50. The merchant system 42 may optionally comprise further servers or server software such as VOIP server, video server, etc.

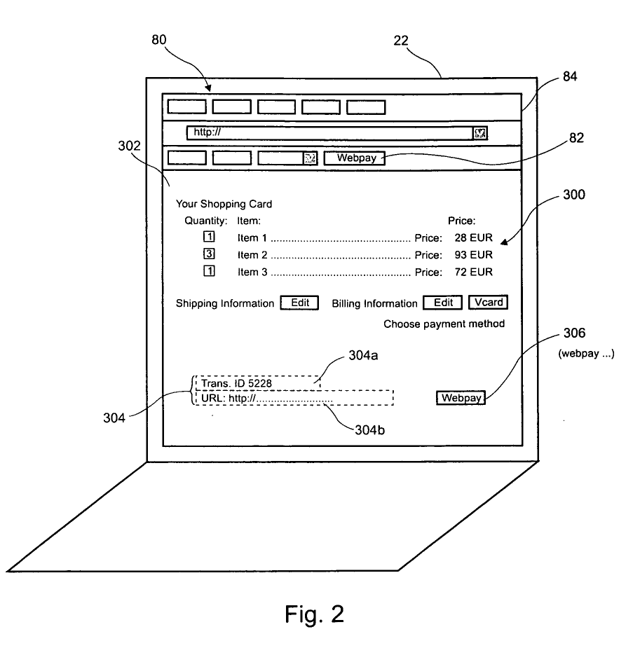

The exemplary embodiment of the merchant system 42 depicted in FIG. 1 comprises a webserver 46, an application server 48, and a database server 50. A purchase offer site 300 (FIG. 2) is hosted on the webserver 46, and can be accessed by the buyer via his communication means 22 and the communication network 12. The purchase offer site 300 is controlled by the application server 48, and the data requested or provided by the buyer on the purchase offer site 300 is processed by the application server 48. Data relating to the purchase offer site 300 is stored at the database server 50. Such data may comprise the list of the offered items (products or services) and the particulars of the offered items (price, information relating to the product or service, discount information, number of items on store, earliest shipping date, file size for downloadable products, etc.), general information about the merchant, user information, user settings for registered users, etc.

The merchant system 42 may comprise a plurality of purchase offer sites 300 belonging to the same or different merchants, which may all be hosted on the webserver 48 and controlled by the application server 48.

The merchant web-pay module 40 provided at the merchant system 42 has a static merchant data store 44 for storing static merchant data, which comprises the merchant's personal data and other merchant related data. The merchant's personal data preferably allows for the identification of the merchant's financial service provider 404 by the buyer's financial service provider 204 and for the identification of the merchant or the merchant's account by the merchant's financial service provider 204. The static merchant data may include similar personal data or other merchant related data as the static buyer data. Alternatively parts or all of the static merchant data may be stored in a static merchant data store 49 of the merchant system 42, and in particularly at the database server 50.

In the case of multi merchant users (and/or multi purchase offer sites 300) the merchant web-pay module 40 may be a multi-user application as well. In this case the static merchant data store 44 may store the static merchant data of all the merchant users. When a plurality of purchase offer sites 300 are provided at the merchant system 42 by the same merchant, it is nevertheless possible that different accounts or even different financial service providers 404 are provided for sales made at the different purchase offer sites 300. Hence the merchant web-pay module's 40 static merchant data store 44 may need to store different merchant data in connection with the different purchase offer sites 300.

The inventive web-pay method is carried out via the exemplary embodiment of the web-pay system 10 as follows.

In the present example the buyer communication means 22 is a computer and the communication network 12 is the Internet. The buyer accesses the purchase offer site 300 hosted by the merchant webserver 46 via a conventional Internet browser application 80 installed on the buyer's computer 22. After having chosen at least one item of purchase the buyer will be able to proceed to check-out in a conventional manner provided for by the purchase offer site 300. Depending on the structure of the purchase offer site 300 and the nature of the offered products or services the buyer is generally navigated to a purchase confirmation page 302, i.e. a check out page (“Your Shopping Cart” page 302 in the present example) where he may review the selected items, their quantity and price as well as the total price (transaction value), he may provide shipping address, billing address or any other information that may be necessary for delivering a product or rendering a service. The requested information depends on the type of products or services offered for sale. For example in case of on-line services (such as watching a movie on-line, or playing with on-line games) or downloadable products (such as images, music, videos) none of the above information is needed—it is sufficient to select the sought products or services. After having provided the necessary data, conventional on-line purchase confirmation pages 302 normally require payment information as well, such as credit card number, name of the card holder, and CVC number. One of the benefits of the invention is that the merchant system 42 and in particular the purchase offer site 300 requires no real modification in order to apply the inventive web-pay system 10 and method. Thus, for example buyers wishing to proceed with conventional on-line payment via credit card may enter the required payment information and thereby authorise the merchant to charge their credit card.

However, at this point a buyer having a buyer web-pay module 20 installed on his computer 22 does not need to give any payment information, instead he may launch his web-pay module 20 to initiate the on-line transaction using the web-pay method according to the invention. The buyer web-pay module 20 may advantageously have a web-pay transaction initiating interface, e.g. in the form of the illustrated “web-pay” button 82, which is provided for activating the buyer web-pay module 20. The web-pay button 82 may be added to the browser's 80 standard toolbar 84, making the use of the web-pay module 20 extremely convenient.

A number of ways are available for allowing the buyer web-pay module 20 to establish a direct connection with the merchant web-pay module 40. For example the purchase offer site 300 may comprise one or more tagged information fields 304, which contain transaction identification code 304a and communication link information 304b (in practice an URL link) for establishing a connection with the merchant web-pay module 40. The buyer web-pay module 20 identifies the information fields 304 via the special tags provided for the buyer web-pay module 20. Preferably the identification fields 304 are hidden fields in order to be read only by the buyer web-pay module 20. The benefit of using one or more tagged information fields 304 is that no other real modification is needed at the merchant system 42 in order to adopt the web-pay method of the present invention at a conventional purchase offer site 300.

The buyer web-pay module 22 opens a new communication session and contacts the merchant web-pay module 40 via the communication network 12 using the communication link information 304b provided on the purchase offer site 300 and transmits the transaction identification code 304a to the merchant web-pay module 40.

The merchant web-pay module 40 uses the transaction identification code 304a to request dynamic transaction data from the merchant system 42—in the present embodiment from the application server 48—and optionally to request part or all of the static merchant data as well. The dynamic transaction data comprises at least the necessary information for creating a transaction order, i.e. at least the transaction value (the total price to be paid). In contrast to conventional on-line transaction methods here the transaction order (or collection order) cannot be issued by the merchant web-pay module 40 since no information is available as regards the buyer's financial service provider 204, credit card, or any other similar information. Instead, the merchant web-pay module 40 creates transaction data using the dynamic transaction data obtained from the merchant system 42 and the static merchant data either stored in the static merchant data store 44 of the merchant web-pay module 40 or obtained partly or entirely from the static merchant data store 49 of the database server 50. The transaction data is sent back to the buyer web-pay module 20 for verification and authentication by the buyer at the buyer's computer 22. In order to enhance the completeness of the verification the dynamic transaction data comprised in the transmitted transaction data preferably contains other information than the total sum of the purchase price as well. For example the dynamic transaction data may include the transaction identification code 304a, the whole list of the selected items and their individual prices as well as the shipping price or any other additional service charge, allowing the buyer to compare the transmitted transaction data with the details of his purchase order placed on the purchase offer site 300.

The static merchant data includes at least merchant identification data for the buyer's financial service provider 204. Such merchant identification data may be the merchant's account number. However, it is sufficient that the merchant identification data comprise data identifying the merchant's financial service provider and data which, when transmitted to the merchant's financial service provider 404, allows the merchant's financial service provider 404 to identify the merchant or the merchant's account. Even information relating to the merchant's financial service provider 404 and/or the merchant's account may be dispensed with. Ultimately, for the real-time notification of the transaction to take place, it is sufficient that the merchant be informed in one way or another of the intended payment, so he may collect the transaction value. For example it may be sufficient to provide the merchant's mobile phone number or e-mail address where he may receive a message informing him of the intended payment and optionally of any information needed for collecting the transaction value. Thus it is sufficient for the merchant identification data to include contact information for sending an intended payment notification to the merchant. Such contact information may be data allowing for the merchant's financial service provider 404 to be contacted (which in turn contacts the merchant or any designee of the merchant), or it may be a mobile phone number, e-mail address, etc. for contacting directly the merchant or any designee of the merchant.

One of the benefits of the invention lies in not having to provide any personal data which may be misused by the other party, thus, although many personal information may be stored in the static merchant data store 44, preferably only such personal static merchant data is transmitted back to the buyer web-pay module 20, which is necessary for the buyer's financial service provider 204 for carrying out the financial transaction or at least for sending an intended payment notification to the merchant or to the merchant's financial service provider 404 or to a third party designated by the merchant to receive such a notification. For example it may be sufficient for the merchant to be informed that a pre-authorisation has been made to the buyer's account or credit card, the sum of which will be remitted to the merchant's bank account or which may be collected by the merchant from the buyer's financial service provider 204. In the latter case a code may be provided in the intended payment notification to be used for collecting the reserved sum, in which case the merchant is not required to give out any information relating to his financial service provider 404.

The static merchant data may also include non-confidential information such as the name of the purchase offer site, its URL link, the name of the merchant, or any other information, which allows the buyer to verify that the transaction data was transmitted in connection with his intended purchase on the visited purchase offer site 300. These and similar data pertaining to the merchant or the purchase offer site 300 may be stored in the static merchant store 40 even in connection with a plurality of merchants and/or purchase offer sites 300. In case there are more than one merchant accounts and/or purchase offer site accounts registered in the web-pay module 40 the necessary information for identifying the merchant and/or purchase offer site 300 may either be included in the transaction identification code 304a or they may be provided by the application server 48 and may be included in the dynamic transaction data in response to the transaction identification code 304a. Differentiation between the various merchant accounts, or purchase offer sites 300 registered in the same web-pay module 40 may also be achieved by allocating different communication link information 304b to each of them.

As an alternative to the above described protocol of establishing a connection between the buyer web-pay module 20 and the merchant web-pay module 40 and obtaining the necessary dynamic transaction data for creating the transaction data, the purchase offer site 300 may comprise a web-pay transaction initiating interface, e.g. in the form of a “web-pay” command 306. When the user activates the web-pay command 306 the request is processed by the merchant system 42, in the present example by the application server 48, which may assist in creating a direct communication between the buyer web-pay module 20 and the merchant web-pay module 40 and/or may activate the merchant web-pay module 40. A number of ways may be envisaged to establish a direct communication between the merchant web-pay module 40 and the buyer web-pay module 20, e.g. the application server 48 may send back communication link information to the buyer's computer 22 via the purchase offer site 300 allowing the buyer web-pay module 20 to contact the merchant web-pay module 40.

Once the direct connection is established the procedure is almost the same as in the first described case, the main difference being that the buyer web-pay module 20 does not necessarily need to obtain and transmit a transaction identification code 304a to the merchant web-pay module 40, since the application server 48 may transmit the dynamic transaction data automatically upon activation of the web-pay command 306 provided on the purchase offer site 300, or when activating the merchant web-pay module 40.

In yet another embodiment the web-pay command 306 provided on the purchase offer site 300 may activate the buyer web-pay module 20, as conventional plug-in software, and the communication link information 304b and optionally the transaction identification code 304a may be provided to the buyer web-pay module 20 upon activation via the web-pay command 306.

As is clear from the above-description a number of options are at hand for creating a direct communication between the buyer web-pay module 20 and the merchant web-pay module 40 and for providing the merchant web-pay module 40 with the necessary dynamic transaction data comprising at least the transaction value.

In all of the above discussed cases the transaction data created by the merchant web-pay module 40 may be, but not necessarily encrypted before transmitting it to the buyer web-pay module 20. Also, preferably a secure connection is used between the buyer web-pay module 20 and the merchant web-pay module 40, but it is not mandatory either.

Upon receipt of the transaction data at the buyer web-pay module 20, the buyer has the opportunity to verify the dynamic transaction data and whether the transaction value and any other optional information correspond to his on-line purchase, then he can choose to authorise the transaction. Part of the transaction data—such as the static merchant data comprising information about the merchant's financial service provider 404 or the merchant's bank account or information for contacting the merchant either directly or indirectly—might not be accessible by the buyer web-pay module 20. If the web-pay system 10 comprises a financial service provider web-pay module 200 at the buyer's financial service provider then the merchant's personal data may be encrypted with a technique that allows only the financial service provider web-pay module 200 to decode the personal data via e.g. a special key provided only for the financial service provider web-pay modules 200, 400. On the other hand, if the transaction order is created in a form that is to be processed by conventional applications then the merchant's personal data needs to be deciphered too in order to be included in the transaction order.

Authorisation by the buyer may be carried out by simply accepting the transaction particulars, e.g. by activating a transaction acceptance button provided in the buyer web-pay module 20. Thereby a transaction order is generated and submitted by the buyer web-pay module 20. Alternatively, generating the transaction order may advantageously include requesting a password from the buyer. For example the data input interface 25 of the buyer web-pay module 20 may comprise an authorisation data input field, and in order to authorise the transaction the buyer must enter authorisation data, such as a password, into the authorisation data input field.

The transaction order is generated by the buyer web-pay module 20 on the basis of the received transaction data and the stored static buyer data. The transaction data need not include all of the received transaction data, it includes preferably at least the transaction value and merchant identification data in order to allow the buyer's financial service provider 204 to arrange for the settlement of the payment, e.g. the merchant's bank account number, or identification of the merchant's financial service provider 404 or information for sending an intended payment notification to the merchant either directly or indirectly (via one or more third parties) so the merchant may collect the transaction value reserved for him.

Not all of the stored static buyer data needs to be included in the transaction order either; the included stored static buyer data preferably comprises buyer identification data allowing the buyer's financial service provider 404 to identify the buyer, such as buyer account number, or buyer identification code.

The transaction order created by the buyer web-pay module 20 is preferably encrypted before transmitting it to the buyer's financial service provider 204 via the communication network 12.

After verification and authorisation of the transaction the transaction order is sent to the buyer's financial service provider 204, where it is advantageously processed by a financial service provider web-pay module 200. Any conventional security measures may be adopted in addition to the previously described forms of authorisation, e.g. the transaction order is not completed before the buyer confirms the order by returning a text message password sent to his mobile phone from the financial service provider 204.

In case the buyer has more than one financial service provider 204 which he can order to carry out the transaction, the particulars of each buyer financial service provider 204 may be stored in the static buyer data store 24. The buyer web-pay module 20 preferably allows for selecting one of the stored financial service providers 204 for carrying out the financial transaction and for adding new financial service providers.

The generated payment order is sent to the financial service provider system 202 via a communication network 12 such as the Internet. The communication network 12 used between the buyer communication means 22 and the merchant system 42 and between the buyer communication means 22 and the financial service provider system 204 need not be the same, for example the communication network 12 between the buyer communication means 22 and the merchant system may be a local area network, e.g. when ordering a movie in a hotel, while the communication network 12 between the buyer communication means 22 and the financial service provider system 202 may be the Internet, or one of the two communication network 12 may be a gsm telecommunication network.

In the present example the transmitted payment order is processed by the financial service provider web-pay module 200 installed on the financial service provider system 202. The web-pay module 200 may determine the transaction value from the dynamic transaction data included in the payment order and may have it checked whether or not sufficient funds are available on the buyer's account. If the required funds are available the transaction value may be reserved for the merchant against the buyer's account allowing for later transfer or withdrawal of the transaction value. If the merchant identification data comprised in the transmitted transaction data includes identification of the merchant's financial service provider 404, the buyer's financial service provider preferably informs the merchant's financial service provider 404 of the intended payment or of the pre-authorisation in advance, even before the actual transaction may take place due to the lengthy processing of payment orders. The merchant's financial system preferably comprises a merchant financial service provider web-pay module 400, and the buyer financial service provider web-pay module 200 transmits the intended payment notification to the merchant financial service provider web-pay module 400 via a communication network 12 such as the Internet. The intended payment notification preferably includes data for identifying the merchant or the merchant's account at the merchant's financial service provider 404. This may be a merchant identification code provided by the merchant's financial service provider 404, which is stored in the static merchant data store 44 of the merchant web-pay module 40 and sent to the buyer web-pay module 20 as part of the merchant identification data included in the transaction data.

The merchant financial service provider web-pay module 400 preferably transmits the intended payment notification to the merchant web-pay module 40 via a communication network 12 such as the Internet. The communication link information of the merchant web-pay module 40 may be stored by the merchant financial service provider web-pay module 400 or it may be included in the static merchant data which has been provided as part of the transaction data and has been forwarded to the merchant financial service provider web-pay module 400 together with the intended payment notification. Notifying the merchant web-pay module 40 of the intended payment allows for real-time on-line transactions to take place. Even if the actual transfer or withdrawal of the transaction value only takes place in the course of conventional payment order processing, which may take considerable time, the merchant is informed in advance and within a very short period via the web-pay system 10 that a pre-authorisation has been made. This allows for real-time on-line transactions to take place, since the merchant can provide on-line products or services without having to wait for the actual sum to be credited to his bank account as the reservation of the transaction value at the buyer's financial service provider 204 serves as a guarantee that the transaction value will be remitted to him.

Optionally, the whole or at least part of the transaction data may be included in the payment order generated by the buyer web-pay module 20 and forwarded to the merchant financial service provider web-pay module 400, which in turn sends it back to the merchant web-pay module 44. This allows the merchant web-pay module to compare the returned transaction data with the original transaction data and to verify that the transaction data has not been corrupted. The part of the transaction data sent back to the merchant web-pay module 40 preferably includes, the transaction identification code 304a, the transaction value. and the merchant identification data, in particular any information identifying the merchant's financial service provider 404, and the merchant's account at the financial service provider 404.

If the merchant identification data comprised in the transaction data and consequently in the transmitted payment order only contains information for notifying the merchant (either directly or indirectly) of the intended payment but no information pertaining to the merchant's financial service provider 404, it is possible to reserve the transaction value and use the information provided in the transaction data to contact the merchant and send him a collection request identification code to be used (either directly or indirectly via one or more third parties) for collecting the transaction value.

Notification of the intended payment (and optionally the collection request identification code) may serve to realise real-time on-line transaction in a similar way as explained in connection with the first example, wherein the merchant is notified via his own financial service provider 404. The merchant is informed of the pre-authorisation in advance, making it possible for him to provide on-line products or render on-line services with guarantee of obtaining the transaction value in due time.

Also, in a preferred embodiment, the method according to the invention comprises transmitting back at least part of the transaction data included in the generated transaction order to the merchant web-pay module 40, thereby allowing the merchant to verify the included transaction data. If the result of the verification is positive, i.e. the transaction data corresponds to that issued by the merchant web-pay module 40 then the merchant may advantageously be required to confirm the intended transaction. Preferably carrying out the financial settlement of the purchase transaction between the buyer and the merchant only takes place after the confirmation is transmitted back to the buyer's financial service provider 204 (possibly via the merchant financial service provider web-pay module at the merchant financial service provider system 402). This protocol avoids carrying out erroneous payment transactions.

In the special case where the buyer's financial service provider 204 and the merchant's financial service provider 404 coincide the buyer financial service provider web-pay module 200 pays the roll of the merchant financial service provider web-pay module 400 as well, in that it identifies the merchant or the merchant's account and sends the intended payment notification to the merchant web-pay module 40.

The foregoing discussion and the drawings are intended to be illustrative, and are not to be taken as limiting. Still other variations and rearrangements of system components are possible and will readily present themselves to those skilled in the art.

1. Method for realising on-line electronic purchase transaction between a buyer having a buyer communication means and a merchant having a merchant system, wherein the buyer communication means and the merchant system are connectable to form a communication network; the method comprising the steps of:
providing a purchase offer site at the merchant system, and configuring the merchant system to allow for selecting at least one item of purchase via the purchase offer site;
providing a merchant web-pay module at the merchant system;
providing a static merchant data store at the merchant system for storing static merchant data including merchant identification data for a financial service provider;
configuring the merchant system for allowing for initiating communication between the buyer communication means and the merchant web-pay module;
providing the merchant web-pay module with dynamic transaction data via the merchant system;
providing the merchant web-pay module with static transaction data from the static merchant data store; and
transmitting transaction data comprising dynamic transaction data and static merchant data to the buyer communication means via the merchant web-pay module; wherein the transaction data allows for a transaction order to be generated.

2. The method according to claim 1, comprising configuring the merchant system to create the dynamic transaction data based on information provided by the buyer in connection with selecting the at least one item of purchase.

3. The method according to claim 1, wherein allowing for initiating communication between the buyer communication means and the merchant web-pay module comprises configuring the merchant system:
to provide a transaction ID for identifying transaction particulars in connection with the items selected on the purchase offer site, and
to provide a communication link information for communication with the merchant web-pay module.

4. The method according to claim 3, further including configuring the merchant system to provide the transaction ID and the communication link information in information fields of the purchase offer site; and to tag the information fields.

5. The method according to claim 1, wherein allowing for initiating communication between the buyer communication means and the merchant web-pay module comprises:
providing a web-pay initiating command on the purchase offer site;
sending the buyer communication means communication link information for establishing a connection with the merchant web-pay module in response to activation of the web-pay initiating command.

6. Method for realising on-line electronic purchase transaction between a buyer having a buyer communication means and a merchant having a merchant system comprising a purchase offer site, the buyer communication means and the merchant system being connectable via a communication network; the method comprising the steps of:
providing a buyer web-pay module at the buyer communication means;
selecting at least one item of purchase on the purchase offer site via the buyer communication means;
requesting transaction data comprising dynamic transaction data and static merchant data from the merchant system by the buyer web-pay module; and
generating a transaction order on the basis of the received transaction data via the buyer web-pay module.

7. The method according to claim 6 wherein the method further comprising:
obtaining via the buyer web-pay module transaction ID and communication link information from the purchase offer site for requesting the transaction data;
sending the transaction ID to a designee defined by the communication link information via the buyer web-pay module;
requesting the transaction data comprising dynamic transaction data and static merchant data—related to the transaction ID—via the buyer web-pay module from the designee defined by the communication link information.

8. The method according to claim 6 comprising:
storing static buyer data by the buyer web-pay module, the static buyer data including buyer identification data for at least one buyer's financial service provider; and
generating a transaction order on the basis of the received transaction data and the stored static buyer data via the buyer web-pay module.

9. The method according to claim 8, comprising:
inputting additional data via a data input interface,
including the inputted additional data in the generated transaction order.

10. The method according to claim 6 comprising:
storing financial service provider identification data by the buyer web-pay module of at least one buyer's financial service provider;
authorising the transaction order,
transmitting the authorised transaction order to at least one buyer's financial service provider via the buyer web-pay module based on the stored financial service provider identification data.

11. The method according to claim 7, further including
providing a browser at the buyer communication means for accessing the merchant's purchase offer site;
providing a web-pay module activation interface on the toolbar of the browser;
activating the web-pay module activation interface; and
establishing a new communication session between the buyer web-pay module and the designee defined by the communication link information.

12. Web-pay system for realising on-line electronic purchase transaction between a buyer and a merchant,
the web-pay system comprising:
a buyer web-pay module adapted to be installed on a buyer communication means;
a merchant web-pay module adapted to be installed on a merchant system which is configured:
to host a purchase offer site;
to allow for selecting at least one item of purchase via the purchase offer site;
to create dynamic transaction data; and
to provide for initiating communication between the buyer web-pay module and the merchant web-pay module;
the buyer web-pay module and the merchant web-pay module being connectable with one another to form a communication network,
the merchant web-pay module being configured:
to obtain dynamic transaction data from the merchant system;
to obtain static merchant data from a static merchant data store;
to provide the buyer web-pay module with transaction data comprising dynamic transaction data and static merchant data; and
the buyer web-pay module being configured to generate a transaction order on the basis of the received transaction data.

13. The web-pay system according to claim 12, wherein the merchant system is further configured:
to provide a transaction ID for identifying dynamic transaction data created in connection with the items selected on the purchase offer site,
to provide communication link information; and
the buyer web-pay module being configured:
to obtain the transaction ID and the communication link information from the merchant system;
to send the transaction ID to the merchant web-pay module for allowing the merchant web-pay module to obtain dynamic transaction data from the merchant system in connection with the transaction ID.

14. The web-pay system according to claim 12, wherein the buyer communication means comprises a browser for accessing the merchant's purchase offer site; and the buyer web-pay module comprises a web-pay module activation interface, which can preferably be added to the toolbar of the browser.

15. The web-pay system according to claim 13, wherein the transaction ID and the communication link information are provided in information fields on the purchase offer site, the information fields being tagged to be recognised by the buyer web-pay module.

16. The web-pay system according to claim 12, wherein the purchase offer site comprises a web-pay initiating command and the merchant system is configured to send to the buyer communication means communication link information for establishing a connection with the merchant web-pay module in response to activation of the web-pay initiating command.

17. The web-pay system according to claim 12, wherein the buyer web-pay module comprises static buyer data store for storing static buyer data including buyer identification data for the buyer's financial service provider; and the buyer web-pay module being further configured to include at least part of the static buyer data in the generated transaction order.

18. The web-pay system according to claim 12, wherein the buyer web-pay module further comprises authorisation data input field for authorising the transaction order.

19. The web-pay system according to claim 18, wherein the static buyer data store of the buyer web-pay module further comprises financial service provider identification data store area for storing information of at least one financial service provider of the buyer; and the buyer web-pay module is further configured to transmit an authorised transaction order to a buyer-selected financial service provider based on the stored financial service provider identification data.

20. The web-pay system according to claim 12, further comprising a financial service provider web-pay module at the buyer's financial service provider; the financial service provider web-pay module being configured:
to receive a transaction order sent by a buyer web-pay module;
to identify the merchant identification data comprising contact information for sending an intended payment notification directly or indirectly to the merchant;
to obtain the transaction value from the dynamic transaction data; and
if sufficient funds are available on the buyer's account, to arrange for reserving the required funds and to send the intended payment notification to the merchant using the contact information.

21. The web-pay system according to claim 20, wherein the merchant identification data comprises information on the merchant's financial service provider; a merchant financial service provider web-pay module is provided at the merchant's financial service provider; the buyer financial service provider web-pay module is configured to send the intended payment notification to the merchant financial service provider web-pay module; and the merchant financial service provider web-pay module is configured to forward the intended payment notification to the merchant web-pay module.

22. Merchant web-pay module for realising on-line electronic purchase transaction between a buyer having a communication means and a merchant having a merchant system, wherein the merchant web-pay module is adapted to be installed on the merchant system, and the merchant web-pay module is connectable with the buyer communication means to form a communication network, and the merchant web-pay module is configured:
to obtain dynamic transaction data from the merchant system;
to obtain static merchant data from a static merchant data store;
to create transaction data comprising dynamic transaction data and static merchant data; and
to transmit the transaction data to the buyer communication means.

23. The merchant web-pay module according to claim 22, wherein the static merchant data store is provided in the merchant web-pay module for storing static merchant data including merchant identification data for a financial service provider.

24. Buyer web-pay module for realising on-line electronic purchase transaction between a buyer having a communication means and a merchant having a merchant system hosting a purchase offer site, wherein the merchant web-pay module is adapted to be installed on the merchant system, and the merchant web-pay module is connectable with the buyer communication means to form a communication network, and the buyer web-pay module is configured:
to obtain transaction ID and communication link information from the merchant system for requesting the transaction data;
to send the transaction ID to a designee defined by the communication link information;
to request transaction data related to the transaction ID from the designee defined by the communication link information; and
generating a transaction order on the basis of the received transaction data.

25. The buyer web-pay module according to claim 24, comprising a web-pay module activation interface, which can preferably be added to a toolbar of an Internet browser.

26. The buyer web-pay module according to claim 24, wherein the buyer web-pay module further comprises authorisation data input field for authorising the transaction order.

27. The buyer web-pay module according to claim 26, wherein the buyer web-pay module comprises static buyer data store for storing static buyer data including buyer identification data for at least one financial service provider of the buyer; and the buyer web-pay module being further configured to include at least part of the static buyer data in the generated transaction order; and the static buyer data store further comprises financial service provider identification data store area for storing information of at least one financial service provider of the buyer; and the buyer web-pay module is further configured to transmit an authorised transaction order to a buyer-selected financial service provider based on the stored financial service provider identification data.
